(19) United States
(12) Patent Application Publication
(10) Pub. No.: US 2016/0027451 A1
(43) Pub. Date: Jan. 28, 2016

(54) System and Method for Providing Noise Suppression Utilizing Null Processing Noise Subtraction

(71) Applicant: Audience, Inc., Mountain View, CA (US)

(72) Inventors: Ludger Solbach, San Jose, CA (US); Carlo Murgia, Sunnyvale, CA (US)

(21) Appl. No.: 14/874,329

(22) Filed: Oct. 2, 2015

Related U.S. Application Data
(63) Continuation of application No. 12/215,980, filed on Jun. 30, 2008, now Pat. No. 9,185,487.

(51) Int. Cl. G10L 21/0232; H04R 3/00; G10L 21/0308

(52) U.S. Cl. CPC G10L 21/0232; G10L 21/0308; H04R 3/005; G10L 2021/02166

(57) ABSTRACT

Systems and methods for noise suppression using noise subtraction processing are provided. The noise subtraction processing comprises receiving at least a primary and a secondary acoustic signal. A desired signal component may be calculated and subtracted from the secondary acoustic signal to obtain a noise component signal. A determination may be made of a reference energy ratio and a prediction energy ratio. A determination may be made as to whether to adjust the noise component signal based partially on the reference energy ratio and partially on the prediction energy ratio. The noise component signal may be adjusted or frozen based on the determination. The noise component signal may then be removed from the primary acoustic signal to generate a noise subtracted signal which may be outputted.

### CROSS-REFERENCE TO RELATED APPLICATIONS

The present application is a Continuation of U.S. patent application Ser. No. 12/215,980, filed Jun. 30, 2008 and entitled “System and Method for Providing Noise Suppression Utilizing Null Processing Noise Subtraction,” which is herein incorporated by reference.

The present application is related to U.S. patent application Ser. No. 11/825,563, filed Jul. 6, 2007 and entitled “System and Method for Adaptive Intelligent Noise Suppression,” (now U.S. Pat. No. 8,744,844), and U.S. patent application Ser. No. 12/080,115, filed Mar. 31, 2008 and entitled “System and Method for Providing Close Microphone Adaptive Array Processing,” (now U.S. Pat. No. 8,204,252), both of which are herein incorporated by reference.

The present application is also related to U.S. patent application Ser. No. 11/343,524, filed Jan. 30, 2006 and entitled “System and Method for Utilizing Inter-Microphone Level Differences for Speech Enhancement,” (now U.S. Pat. No. 8,345,890), and U.S. patent application Ser. No. 11/699,732, filed Jan. 29, 2007 and entitled “System and Method for Utilizing Omni-Directional Microphones for Speech Enhancement,” (now U.S. Pat. No. 8,194,880), both of which are herein incorporated by reference.

### BACKGROUND

1. Field of Technology

The present technology relates generally to audio processing and more particularly to adaptive noise suppression of an audio signal.

2. Description of Related Art

Currently, there are many methods for reducing background noise in an adverse audio environment. One such method is to use a stationary noise suppression system. The stationary noise suppression system will always provide an output noise that is a fixed amount lower than the input noise. Typically, the stationary noise suppression is in the range of 12-13 decibels (dB). The noise suppression is fixed to this conservative level in order to avoid producing speech distortion, which will be apparent with higher noise suppression.

In order to provide higher noise suppression, dynamic noise suppression systems based on signal-to-noise ratios (SNR) have been utilized. This SNR may then be used to determine a suppression value. Unfortunately, SNR, by itself, is not a very good predictor of speech distortion due to existence of different noise types in the audio environment. SNR is a ratio of how much louder speech is than noise. However, speech may be a non-stationary signal which may constantly change and contain pauses. Typically, speech energy, over a period of time, will comprise a word, a pause, a word, a pause, and so forth. Additionally, stationary and dynamic noises may be present in the audio environment. The SNR averages all of these stationary and non-stationary speech and noise. There is no consideration as to the statistics of the noise signal; only what the overall level of noise is.

In some prior art systems, an enhancement filter may be derived based on an estimate of a noise spectrum. One common enhancement filter is the Wiener filter. Disadvantageously, the enhancement filter is typically configured to minimize certain mathematical error quantities, without taking into account a user's perception. As a result, a certain amount of speech degradation is introduced as a side effect of the noise suppression. This speech degradation will become more severe as the noise level rises and more noise suppression is applied. That is, as the SNR gets lower, lower gain is applied resulting in more noise suppression. This introduces more speech loss distortion and speech degradation.

Some prior art systems invoke a generalized side-lobe canceller. The generalized side-lobe canceller is used to identify desired signals and interfering signals comprised by a received signal. The desired signals propagate from a desired location and the interfering signals propagate from other locations. The interfering signals are subtracted from the received signal with the intention of cancelling interference.

Many noise suppression processes calculate a masking gain and apply this masking gain to an input signal. Thus, if an audio signal is mostly noise, a masking gain that is a low value may be applied (i.e., multiplied to) the audio signal. Conversely, if the audio signal is mostly desired sound, such as speech, a high value gain mask may be applied to the audio signal. This process is commonly referred to as multiplicative noise suppression.

### SUMMARY

Embodiments of the present technology overcome or substantially alleviate prior problems associated with noise suppression and speech enhancement. In exemplary embodiments, at least a primary and a secondary acoustic signal are received by a microphone array. The microphone array may comprise a close microphone array or a spread microphone array.

A noise component signal may be determined in each sub-band of signals received by the microphone by subtracting the primary acoustic signal weighted by a complex-valued coefficient σ from the secondary acoustic signal. The noise component signal, weighted by another complex-valued coefficient α, may then be subtracted from the primary acoustic signal resulting in an estimate of a target signal (i.e., a noise subtracted signal).

A determination may be made as to whether to adjust a. In exemplary embodiments, the determination may be based on a reference energy ratio (g₁) and a prediction energy ratio (g₂). The complex-valued coefficient α may be adapted when the prediction energy ratio is greater than the reference energy ratio to adjust the noise component signal. Conversely, the adaptation coefficient may be frozen when the prediction energy ratio is less than the reference energy ratio. The noise component signal may then be removed from the primary acoustic signal to generate a noise subtracted signal which may be outputted.

### BRIEF DESCRIPTION OF THE DRAWINGS

FIG. 1 is an environment in which embodiments of the present technology may be practiced.

FIG. 2 is a block diagram of an exemplary audio device implementing embodiments of the present technology.

FIG. 3 is a block diagram of an exemplary audio processing system utilizing a spread microphone array.

FIG. 4 is a block diagram of an exemplary noise suppression system of the audio processing system of FIG. 3.

FIG. 5 is a block diagram of an exemplary audio processing system utilizing a close microphone array.

FIG. 6 is a block diagram of an exemplary noise suppression system of the audio processing system of FIG. 5.

FIG. 7a is a block diagram of an exemplary noise subtraction engine.

FIG. 7b is a schematic illustrating the operations of the noise subtraction engine.

FIG. 8 is a flowchart of an exemplary method for suppressing noise in an audio device.

FIG. 9 is a flowchart of an exemplary method for performing noise subtraction processing.

### DETAILED DESCRIPTION

The present technology provides exemplary systems and methods for adaptive suppression of noise in an audio signal. Embodiments attempt to balance noise suppression with minimal or no speech degradation (i.e., speech loss distortion). In exemplary embodiments, noise suppression is based on an audio source location and applies a subtractive noise suppression process as opposed to a purely multiplicative noise suppression process.

Embodiments of the present technology may be practiced on any audio device that is configured to receive sound such as, but not limited to, cellular phones, phone handsets, headsets, and conferencing systems. Advantageously, exemplary embodiments are configured to provide improved noise suppression while minimizing speech distortion. While some embodiments of the present technology will be described in reference to operation on a cellular phone, the present technology may be practiced on any audio device.

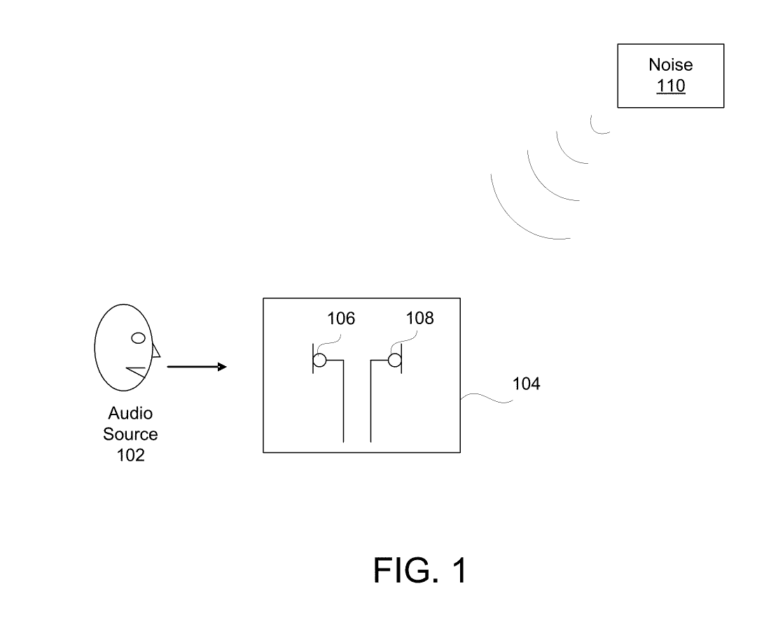

Referring to FIG. 1, an environment in which embodiments of the present technology may be practiced is shown. A user acts as a speech (audio) source 102 to an audio device 104. The exemplary audio device 104 may include a microphone array. The microphone array may comprise a close microphone array or a spread microphone array.

In exemplary embodiments, the microphone array may comprise a primary microphone 106 relative to the audio source 102 and a secondary microphone 108 located a distance away from the primary microphone 106. While embodiments of the present technology will be discussed with regards to having two microphones 106 and 108, alternative embodiments may contemplate any number of microphones or acoustic sensors within the microphone array. In some embodiments, the microphones 106 and 108 may comprise omni-directional microphones.

While the microphones 106 and 108 receive sound (i.e., acoustic signals) from the audio source 102, the microphones 106 and 108 also pick up noise 110. Although the noise 110 is shown coming from a single location in FIG. 1, the noise 110 may comprise any sounds from one or more locations different than the audio source 102, and may include reverberations and echoes. The noise 110 may be stationary, non-stationary, or a combination of both stationary and non-stationary noise.

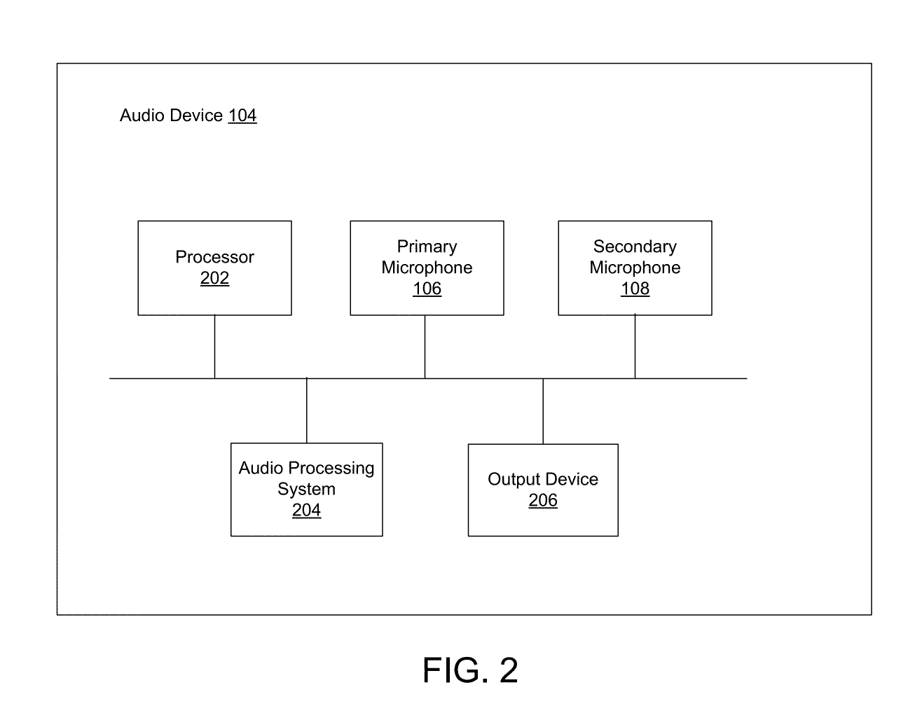

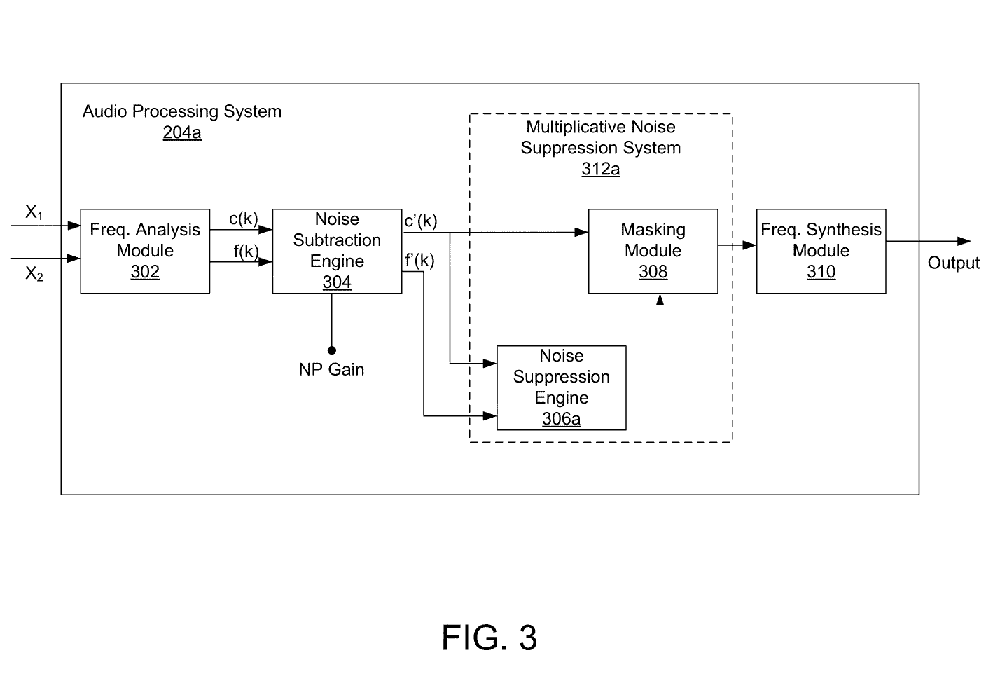

Referring now to FIG. 2, the exemplary audio device 104 is shown in more detail. In exemplary embodiments, the audio device 104 is an audio receiving device that comprises a processor 202, the primary microphone 106, the secondary microphone 108, an audio processing system 204, and an output device 206. The audio device 104 may comprise further components (not shown) necessary for audio device 104 operations. The audio processing system 204 will be discussed in more details in connection with FIG. 3.

In exemplary embodiments, the primary and secondary microphones 106 and 108 are spaced a distance apart in order to allow for an energy level difference between them. Upon reception by the microphones 106 and 108, the acoustic signals may be converted into electric signals (i.e., a primary electric signal and a secondary electric signal). The electric signals may, themselves, be converted by an analog-to-digital converter (not shown) into digital signals for processing in accordance with some embodiments. In order to differentiate the acoustic signals, the acoustic signal received by the primary microphone 106 is herein referred to as the primary acoustic signal, while the acoustic signal received by the secondary microphone 108 is herein referred to as the secondary acoustic signal.

The output device 206 is any device which provides an audio output to the user. For example, the output device 206 may comprise an earpiece of a headset or handset, or a speaker on a conferencing device.

FIG. 3 is a detailed block diagram of the exemplary audio processing system 204a according to one embodiment of the present technology. In exemplary embodiments, the audio processing system 204a is embodied within a memory device. The audio processing system 204a of FIG. 3 may be utilized in embodiments comprising a spread microphone array.

In operation, the acoustic signals received from the primary and secondary microphones 106 and 108 are converted to electric signals and processed through a frequency analysis module 302. In one embodiment, the frequency analysis module 302 takes the acoustic signals and mimics the frequency analysis of the cochlea (i.e., cochlear domain) simulated by a filter bank. In one example, the frequency analysis module 302 separates the acoustic signals into frequency sub-bands. A sub-band is the result of a filtering operation on an input signal where the bandwidth of the filter is narrower than the bandwidth of the signal received by the frequency analysis module 302. Alternatively, other filters such as short-time Fourier transform (STFT), sub-band filter banks, modulated complex lapped transforms, cochlear models, wavelets, etc., can be used for the frequency analysis and synthesis. Because most sounds (e.g., acoustic signals) are complex and comprise more than one frequency, a sub-band analysis on the acoustic signal determines what individual frequencies are present in the complex acoustic signal during a frame (e.g., a predetermined period of time). According to one embodiment, the frame is 8 ms long. Alternative embodiments may utilize other frame lengths or no frame at all. The results may comprise sub-band signals in a fast cochlea transform (FCT) domain.

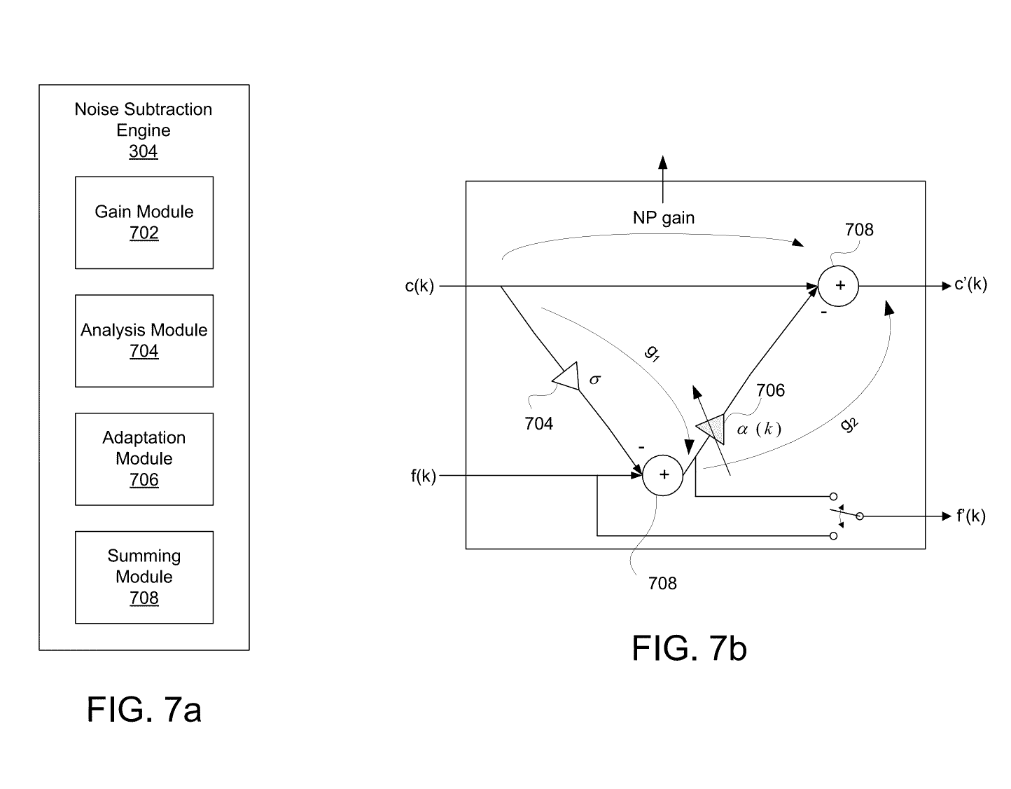

Once the sub-band signals are determined, the sub-band signals are forwarded to a noise subtraction engine 304. The exemplary noise subtraction engine 304 is configured to adaptively subtract out a noise component from the primary acoustic signal for each sub-band. As such, output of the noise subtraction engine 304 is a noise subtracted signal comprised of noise subtracted sub-band signals. The noise subtraction engine 304 will be discussed in more detail in connection with FIG. 7a and FIG. 7b. It should be noted that the noise subtracted sub-band signals may comprise desired audio that is speech or non-speech (e.g., music). The results of the noise subtraction engine 304 may be output to the user or processed through a further noise suppression system (e.g., the noise suppression engine 306). For purposes of illustration, embodiments of the present technology will discuss embodiments whereby the output of the noise subtraction engine 304 is processed through a further noise suppression system.

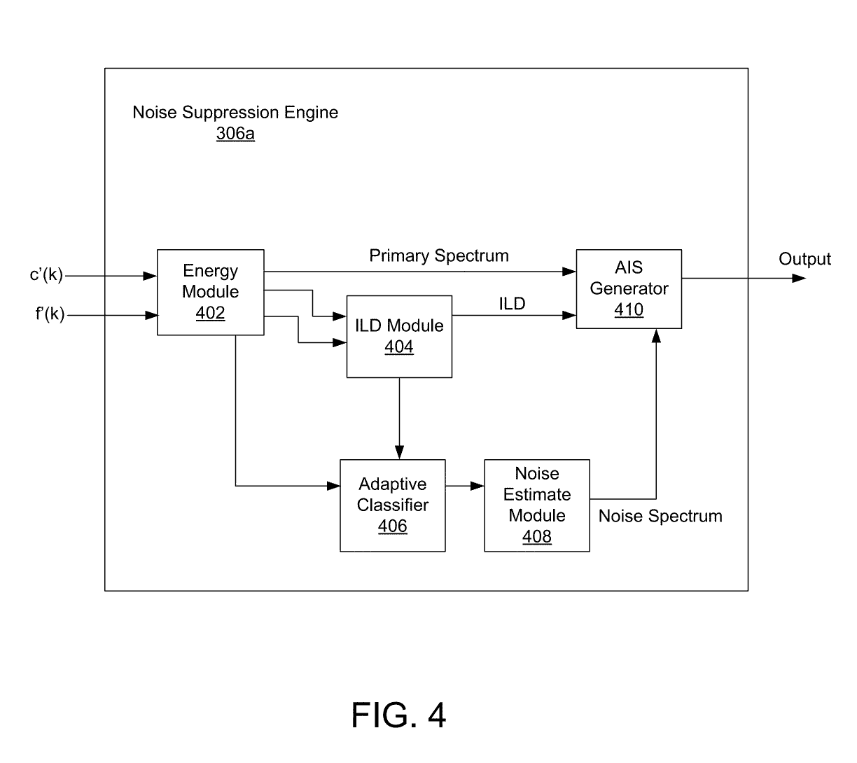

The noise subtracted sub-band signals along with the sub-band signals of the secondary acoustic signal are then provided to the noise suppression engine 306a. According to exemplary embodiments, the noise suppression engine 306a generates a gain mask to be applied to the noise subtracted sub-band signals in order to further reduce noise components that remain in the noise subtracted speech signal. The noise suppression engine 306a will be discussed in more detail in connection with FIG. 4 below.

The gain mask determined by the noise suppression engine 306a may then be applied to the noise subtracted signal in a masking module 308. Accordingly, each gain mask may be applied to an associated noise subtracted frequency sub-band to generate masked frequency sub-bands. As depicted in FIG. 3, a multiplicative noise suppression system 312a comprises the noise suppression engine 306a and the masking module 308.

Next, the masked frequency sub-bands are converted back into time domain from the cochlea domain. The conversion may comprise taking the masked frequency sub-bands and adding together phase shifted signals of the cochlea channels in a frequency synthesis module 310. Alternatively, the conversion may comprise taking the masked frequency sub-bands and multiplying these with an inverse frequency of the cochlea channels in the frequency synthesis module 310. Once conversion is completed, the synthesized acoustic signal may be output to the user.

Referring now to FIG. 4, the noise suppression engine 306a of FIG. 3 is illustrated. The exemplary noise suppression engine 306a comprises an energy module 402, an inter-microphone level difference (ILD) module 404, an adaptive classifier 406, a noise estimate module 408, and an adaptive intelligent suppression (AIS) generator 410. It should be noted that the noise suppression engine 306a is exemplary and may comprise other combinations of modules such as that shown and described in U.S. patent application Ser. No. 11/343,524, which is incorporated by reference.

According to an exemplary embodiment of the present technology, the AIS generator 410 derives time and frequency varying gains or gain masks used by the masking module 308 to suppress noise and enhance speech in the noise subtracted signal. In order to derive the gain masks, however, specific inputs are needed for the AIS generator 410. These inputs comprise a power spectral density of noise (i.e., noise spectrum), a power spectral density of the noise subtracted signal (herein referred to as the primary spectrum), and an inter-microphone level difference (ILD).

According to exemplary embodiment, the noise subtracted signal (c′(k)) resulting from the noise subtraction engine 304 and the secondary acoustic signal (f′(k)) are forwarded to the energy module 402 which computes energy/power estimates during an interval of time for each frequency band (i.e., power estimates) of an acoustic signal. As can be seen in FIG. 7b, f′(k) may optionally be equal to f(k). As a result, the primary spectrum (i.e., the power spectral density of the noise subtracted signal) across all frequency bands may be determined by the energy module 402. This primary spectrum may be supplied to the AIS generator 410 and the ILD module 404 (discussed further herein). Similarly, the energy module 402 determines a secondary spectrum (i.e., the power spectral density of the secondary acoustic signal) across all frequency bands which is also supplied to the ILD module 404. More details regarding the calculation of power estimates and power spectrums can be found in co-pending U.S. patent application Ser. No. 11/343,524 and co-pending U.S. patent application Ser. No. 11/699,732, which are incorporated by reference.

In two microphone embodiments, the power spectrums are used by an inter-microphone level difference (ILD) module 404 to determine an energy ratio between the primary and secondary microphones 106 and 108. In exemplary embodiments, the ILD may be a time and frequency varying ILD. Because the primary and secondary microphones 106 and 108 may be oriented in a particular way, certain level differences may occur when speech is active and other level differences may occur when noise is active. The ILD is then forwarded to the adaptive classifier 406 and the AIS generator 410. More details regarding one embodiment for calculating ILD may be can be found in co-pending U.S. patent application Ser. No. 11/343,524 and co-pending U.S. patent application Ser. No. 11/699,732. In other embodiments, other forms of ILD or energy differences between the primary and secondary microphones 106 and 108 may be utilized. For example, a ratio of the energy of the primary and secondary microphones 106 and 108 may be used. It should also be noted that alternative embodiments may use cues other than ILD for adaptive classification and noise suppression (i.e., gain mask calculation). For example, noise floor thresholds may be used. As such, references to the use of ILD may be construed to be applicable to other cues.

The exemplary adaptive classifier 406 is configured to differentiate noise and distractors (e.g., sources with a negative ILD) from speech in the acoustic signal(s) for each frequency band in each frame. The adaptive classifier 406 is considered adaptive because features (e.g., speech, noise, and distractors) change and are dependent on acoustic conditions in the environment. For example, an ILD that indicates speech in one situation may indicate noise in another situation. Therefore, the adaptive classifier 406 may adjust classification boundaries based on the ILD.

According to exemplary embodiments, the adaptive classifier 406 differentiates noise and distractors from speech and provides the results to the noise estimate module 408 which derives the noise estimate. Initially, the adaptive classifier 406 may determine a maximum energy between channels at each frequency. Local ILDs for each frequency are also determined. A global ILD may be calculated by applying the energy to the local ILDs. Based on the newly calculated global ILD, a running average global ILD and/or a running mean and variance (i.e., global cluster) for ILD observations may be updated. Frame types may then be classified based on a position of the global ILD with respect to the global cluster. The frame types may comprise source, background, and distractors.

Once the frame types are determined, the adaptive classifier 406 may update the global average running mean and variance (i.e., cluster) for the source, background, and distractors. In one example, if the frame is classified as source, background, or distracter, the corresponding global cluster is considered active and is moved toward the global ILD. The global source, background, and distractor global clusters that do not match the frame type are considered inactive. Source and distractor global clusters that remain inactive for a predetermined period of time may move toward the background global cluster. If the background global cluster remains inactive for a predetermined period of time, the background global cluster moves to the global average.

Once the frame types are determined, the adaptive classifier 406 may also update the local average running mean and variance (i.e., cluster) for the source, background, and distractors. The process of updating the local active and inactive clusters is similar to the process of updating the global active and inactive clusters.

Based on the position of the source and background clusters, points in the energy spectrum are classified as source or noise; this result is passed to the noise estimate module 408.

In an alternative embodiment, an example of an adaptive classifier 406 comprises one that tracks a minimum ILD in each frequency band using a minimum statistics estimator. The classification thresholds may be placed a fixed distance (e.g., 3 dB) above the minimum ILD in each band. Alternatively, the thresholds may be placed a variable distance above the minimum ILD in each band, depending on the recently observed range of ILD values observed in each band. For example, if the observed range of ILDs is beyond 6 dB, a threshold may be place such that it is midway between the minimum and maximum ILDs observed in each band over a certain specified period of time (e.g., 2 seconds). The adaptive classifier is further discussed in the U.S. nonprovisional application entitled “System and Method for Adaptive Intelligent Noise Suppression,” Ser. No. 11/825,563, filed Jul. 6, 2007, which is incorporated by reference.

In exemplary embodiments, the noise estimate is based on the acoustic signal from the primary microphone 106 and the results from the adaptive classifier 406. The exemplary noise estimate module 408 generates a noise estimate which is a component that can be approximated mathematically by

N(t,ω)=λ₁(t,ω)E₁(t,ω)+(1−λ₁(t,ω))min[N(t−1,ω),E₁(t,ω)]

according to one embodiment of the present technology. As shown, the noise estimate in this embodiment is based on minimum statistics of a current energy estimate of the primary acoustic signal, E₁(t,ω) and a noise estimate of a previous time frame, N(t−1,ω). As a result, the noise estimation is performed efficiently and with low latency.

λ₁(t,ω) in the above equation may be derived from the ILD approximated by the ILD module 404, as

$${λ}_{I} ( t , ω ) = \{ \begin{matrix}\approx 0 & if ILD ( t , ω ) < threshold \\ \approx 1 & if ILD ( t , ω ) > threshold\end{matrix}$$

That is, when the primary microphone 106 is smaller than a threshold value (e.g., threshold=0.5) above which speech is expected to be, λ₁ is small, and thus the noise estimate module 408 follows the noise closely. When ILD starts to rise (e.g., because speech is present within the large ILD region), λ₁ increases. As a result, the noise estimate module 408 slows down the noise estimation process and the speech energy does not contribute significantly to the final noise estimate. Alternative embodiments, may contemplate other methods for determining the noise estimate or noise spectrum. The noise spectrum (i.e., noise estimates for all frequency bands of an acoustic signal) may then be forwarded to the AIS generator 410.

The AIS generator 410 receives speech energy of the primary spectrum from the energy module 402. This primary spectrum may also comprise some residual noise after processing by the noise subtraction engine 304. The AIS generator 410 may also receive the noise spectrum from the noise estimate module 408. Based on these inputs and an optional ILD from the ILD module 404, a speech spectrum may be inferred. In one embodiment, the speech spectrum is inferred by subtracting the noise estimates of the noise spectrum from the power estimates of the primary spectrum. Subsequently, the AIS generator 410 may determine gain masks to apply to the primary acoustic signal. More detailed discussion of the AIS generator 410 may be found in U.S. patent application Ser. No. 11/825,563 entitled “System and Method for Adaptive Intelligent Noise Suppression,” which is incorporated by reference. In exemplary embodiments, the gain mask output from the AIS generator 410, which is time and frequency dependent, will maximize noise suppression while constraining speech loss distortion.

It should be noted that the system architecture of the noise suppression engine 306a is exemplary. Alternative embodiments may comprise more components, less components, or equivalent components and still be within the scope of embodiments of the present technology. Various modules of the noise suppression engine 306a may be combined into a single module. For example, the functionalities of the ILD module 404 may be combined with the functions of the energy module 402.

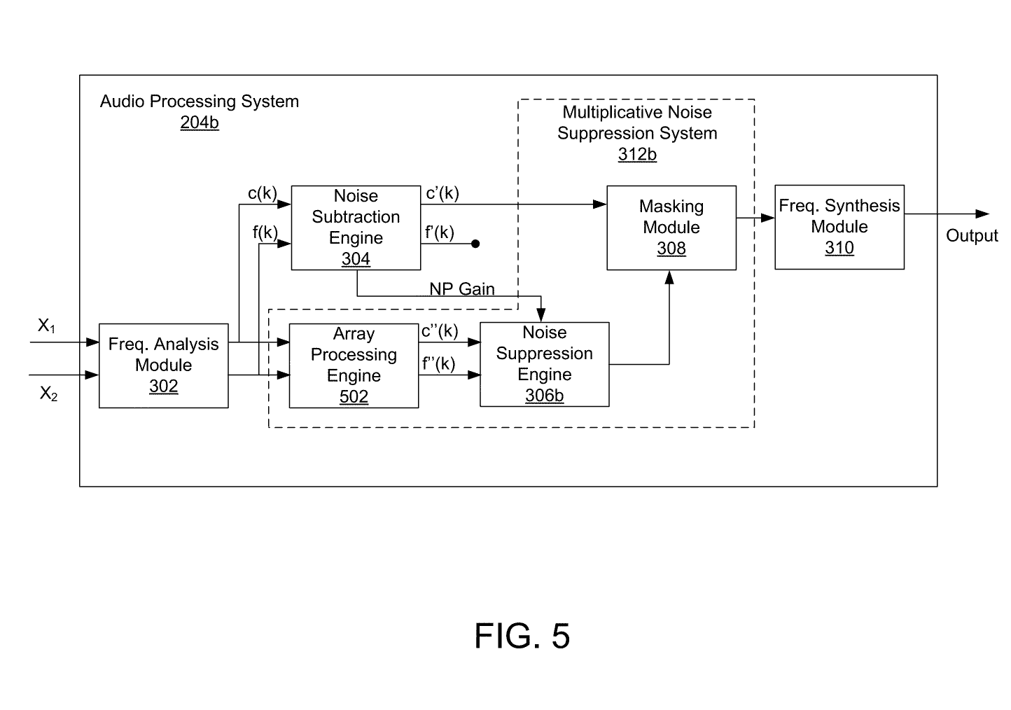

Referring now to FIG. 5, a detailed block diagram of an alternative audio processing system 204b is shown. In contrast to the audio processing system 204a of FIG. 3, the audio processing system 204b of FIG. 5 may be utilized in embodiments comprising a close microphone array. The functions of the frequency analysis module 302, masking module 308, and frequency synthesis module 310 are identical to those described with respect to the audio processing system 204a of FIG. 3 and will not be discussed in detail.

The sub-band signals determined by the frequency analysis module 302 may be forwarded to the noise subtraction engine 304 and an array processing engine 502. The exemplary noise subtraction engine 304 is configured to adaptively subtract out a noise component from the primary acoustic signal for each sub-band. As such, output of the noise subtraction engine 304 is a noise subtracted signal comprised of noise subtracted sub-band signals. In the present embodiment, the noise subtraction engine 304 also provides a null processing (NP) gain to the noise suppression engine 306a. The NP gain comprises an energy ratio indicating how much of the primary signal has been cancelled out of the noise subtracted signal. If the primary signal is dominated by noise, then NP gain will be large. In contrast, if the primary signal is dominated by speech, NP gain will be close to zero. The noise subtraction engine 304 will be discussed in more detail in connection with FIG. 7a and FIG. 7b below.

In exemplary embodiments, the array processing engine 502 is configured to adaptively process the sub-band signals of the primary and secondary signals to create directional patterns (i.e., synthetic directional microphone responses) for the close microphone array (e.g., the primary and secondary microphones 106 and 108). The directional patterns may comprise a forward-facing cardioid pattern based on the primary acoustic (sub-band) signals and a backward-facing cardioid pattern based on the secondary (sub-band) acoustic signal. In one embodiment, the sub-band signals may be adapted such that a null of the backward-facing cardioid pattern is directed towards the audio source 102. More details regarding the implementation and functions of the array processing engine 502 may be found (referred to as the adaptive array processing engine) in U.S. patent application Ser. No. 12/080,115 entitled “System and Method for Providing Close Microphone Array Noise Reduction,” which is incorporated by reference. The cardioid signals (i.e., a signal implementing the forward-facing cardioid pattern and a signal implementing the backward-facing cardioid pattern) are then provided to the noise suppression engine 306b by the array processing engine 502.

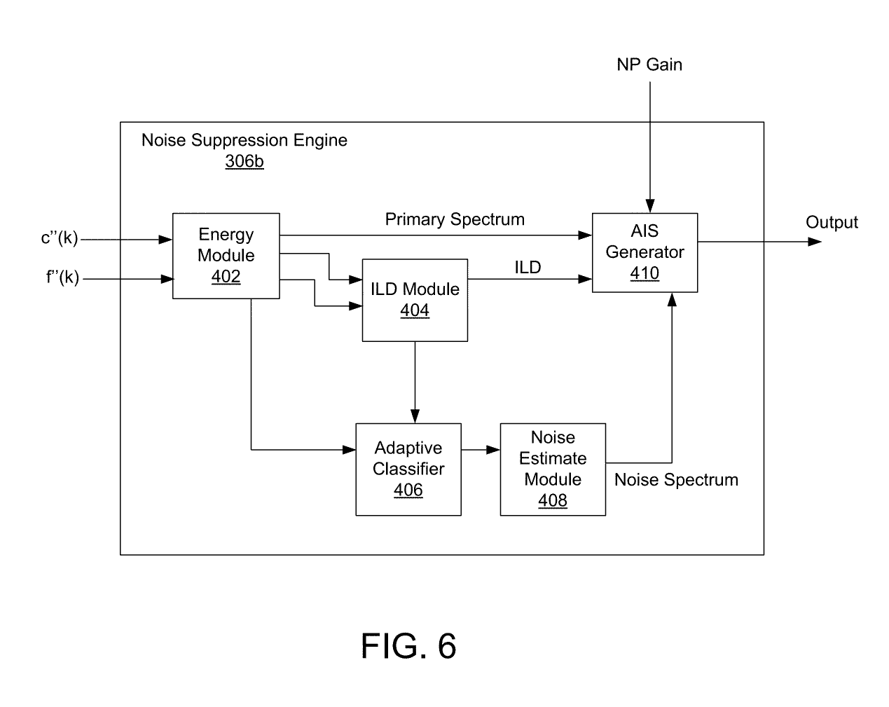

The noise suppression engine 306b receives the NP gain along with the cardioid signals. According to exemplary embodiments, the noise suppression engine 306b generates a gain mask to be applied to the noise subtracted sub-band signals from the noise subtraction engine 304 in order to further reduce any noise components that may remain in the noise subtracted speech signal. The noise suppression engine 306b will be discussed in more detail in connection with FIG. 6 below.

The gain mask determined by the noise suppression engine 306b may then be applied to the noise subtracted signal in the masking module 308. Accordingly, each gain mask may be applied to an associated noise subtracted frequency sub-band to generate masked frequency sub-bands. Subsequently, the masked frequency sub-bands are converted back into time domain from the cochlea domain by the frequency synthesis module 310. Once conversion is completed, the synthesized acoustic signal may be output to the user. As depicted in FIG. 5, a multiplicative noise suppression system 312b comprises the array processing engine 502, the noise suppression engine 306b, and the masking module 308.

Referring now to FIG. 6, the exemplary noise suppression engine 306b is shown in more detail. The exemplary noise suppression engine 306b comprises the energy module 402, the inter-microphone level difference (ILD) module 404, the adaptive classifier 406, the noise estimate module 408, and the adaptive intelligent suppression (AIS) generator 410. It should be noted that the various modules of the noise suppression engine 306b functions similar to the modules in the noise suppression engine 306a.

In the present embodiment, the primary acoustic signal (c″(k)) and the secondary acoustic signal (f″(k)) are received by the energy module 402 which computes energy/power estimates during an interval of time for each frequency band (i.e., power estimates) of an acoustic signal. As a result, the primary spectrum (i.e., the power spectral density of the primary sub-band signals) across all frequency bands may be determined by the energy module 402. This primary spectrum may be supplied to the AIS generator 410 and the ILD module 404. Similarly, the energy module 402 determines a secondary spectrum (i.e., the power spectral density of the secondary sub-band signal) across all frequency bands which is also supplied to the ILD module 404. More details regarding the calculation of power estimates and power spectrums can be found in co-pending U.S. patent application Ser. No. 11/343,524 and co-pending U.S. patent application Ser. No. 11/699,732, which are incorporated by reference.

As previously discussed, the power spectrums may be used by the ILD module 404 to determine an energy difference between the primary and secondary microphones 106 and 108. The ILD may then be forwarded to the adaptive classifier 406 and the AIS generator 410. In alternative embodiments, other forms of ILD or energy differences between the primary and secondary microphones 106 and 108 may be utilized. For example, a ratio of the energy of the primary and secondary microphones 106 and 108 may be used. It should also be noted that alternative embodiments may use cues other than ILD for adaptive classification and noise suppression (i.e., gain mask calculation). For example, noise floor thresholds may be used. As such, references to the use of ILD may be construed to be applicable to other cues.

The exemplary adaptive classifier 406 and noise estimate module 408 perform the same functions as that described in accordance with FIG. 4. That is, the adaptive classifier differentiates noise and distractors from speech and provides the results to the noise estimate module 408 which derives the noise estimate.

The AIS generator 410 receives speech energy of the primary spectrum from the energy module 402. The AIS generator 410 may also receive the noise spectrum from the noise estimate module 408. Based on these inputs and an optional ILD from the ILD module 404, a speech spectrum may be inferred. In one embodiment, the speech spectrum is inferred by subtracting the noise estimates of the noise spectrum from the power estimates of the primary spectrum. Additionally, the AIS generator 410 uses the NP gain, which indicates how much noise has already been cancelled by the time the signal reaches the noise suppression engine 306b (i.e., the multiplicative mask) to determine gain masks to apply to the primary acoustic signal. In one example, as the NP gain increases, the estimated SNR for the inputs decreases. In exemplary embodiments, the gain mask output from the AIS generator 410, which is time and frequency dependent, may maximize noise suppression while constraining speech loss distortion.

It should be noted that the system architecture of the noise suppression engine 306b is exemplary. Alternative embodiments may comprise more components, less components, or equivalent components and still be within the scope of embodiments of the present technology.

FIG. 7a is a block diagram of an exemplary noise subtraction engine 304. The exemplary noise subtraction engine 304 is configured to suppress noise using a subtractive process. The noise subtraction engine 304 may determine a noise subtracted signal by initially subtracting out a desired component (e.g., the desired speech component) from the primary signal in a first branch, thus resulting in a noise component. Adaptation may then be performed in a second branch to cancel out the noise component from the primary signal. In exemplary embodiments, the noise subtraction engine 304 comprises a gain module 702, an analysis module 704, an adaptation module 706, and at least one summing module 708 configured to perform signal subtraction. The functions of the various modules 702-708 will be discussed in connection with FIG. 7a and further illustrated in operation in connection with FIG. 7b.

Referring to FIG. 7a, the exemplary gain module 702 is configured to determine various gains used by the noise subtraction engine 304. For purposes of the present embodiment, these gains represent energy ratios. In the first branch, a reference energy ratio (g₁) of how much of the desired component is removed from the primary signal may be determined. In the second branch, a prediction energy ratio (g₂) of how much the energy has been reduced at the output of the noise subtraction engine 304 from the result of the first branch may be determined. Additionally, an energy ratio (i.e., NP gain) may be determined that represents the energy ratio indicating how much noise has been canceled from the primary signal by the noise subtraction engine 304. As previously discussed, NP gain may be used by the AIS generator 410 in the close microphone embodiment to adjust the gain mask.

The exemplary analysis module 704 is configured to perform the analysis in the first branch of the noise subtraction engine 304, while the exemplary adaptation module 706 is configured to perform the adaptation in the second branch of the noise subtraction engine 304.

Referring to FIG. 7b, a schematic illustrating the operations of the noise subtraction engine 304 is shown. Sub-band signals of the primary microphone signal c(k) and secondary microphone signal f(k) are received by the noise subtraction engine 304 where k represents a discrete time or sample index. c(k) represents a superposition of a speech signal s(k) and a noise signal n(k). f(k) is modeled as a superposition of the speech signal s(k), scaled by a complex-valued coefficient σ, and the noise signal n(k), scaled by a complex-valued coefficient ν. ν represents how much of the noise in the primary signal is in the secondary signal. In exemplary embodiments, ν is unknown since a source of the noise may be dynamic.

In exemplary embodiments, σ is a fixed coefficient that represents a location of the speech (e.g., an audio source location). In accordance with exemplary embodiments, σ may be determined through calibration. Tolerances may be included in the calibration by calibrating based on more than one position. For a close microphone, a magnitude of σ may be close to one. For spread microphones, the magnitude of σ may be dependent on where the audio device 102 is positioned relative to the speaker's mouth. The magnitude and phase of the σ may represent an inter-channel cross-spectrum for a speaker's mouth position at a frequency represented by the respective sub-band (e.g., Cochlea tap). Because the noise subtraction engine 304 may have knowledge of what σ is, the analysis module 704 may apply σ to the primary signal (i.e., σ(s(k)+n(k)) and subtract the result from the secondary signal (i.e., σs(k)+ν(k)) in order to cancel out the speech component σ s(k) (i.e., the desired component) from the secondary signal resulting in a noise component out of the summing module 708. In an embodiment where there is not speech, α is approximately 1/(ν—σ), and the adaptation module 706 may freely adapt.

If the speaker's mouth position is adequately represented by a, then f(k)−σc(k)=(ν−σ)n(k). This equation indicates that signal at the output of the summing module 708 being fed into the adaptation module 706 (which, in turn, applies an adaptation coefficient α(k)) may be devoid of a signal originating from a position represented by σ (e.g., the desired speech signal). In exemplary embodiments, the analysis module 704 applies σ to the secondary signal f(k) and subtracts the result from c(k). Remaining signal (referred to herein as “noise component signal”) from the summing module 708 may be canceled out in the second branch.

The adaptation module 706 may adapt when the primary signal is dominated by audio sources 102 not in the speech location (represented by σ). If the primary signal is dominated by a signal originating from the speech location as represented by σ, adaptation may be frozen. In exemplary embodiments, the adaptation module 706 may adapt using one of a common least-squares method in order to cancel the noise component n(k) from the signal c(k). The coefficient may be update at a frame rate according to on embodiment.

In an embodiment where n(k) is white and a cross-correlation between s(k) and n(k) is zero within a frame, adaptation may happen every frame with the noise n(k) being perfectly cancelled and the speech s(k) being perfectly unaffected. However, it is unlikely that these conditions may be met in reality, especially if the frame size is short. As such, it is desirable to apply constraints on adaptation. In exemplary embodiments, the adaptation coefficient α(k) may be updated on a per-tap/per-frame basis when the reference energy ratio g₁ and the prediction energy ratio g₂ satisfy the follow condition:

g₂·γ>g₁/γ

where γ>0. Assuming, for example, that \hat{σ}(k)=σ, α(k)=1/(ν−σ), and s(k) and n(k) are uncorrelated, the following may be obtained:

$${g}_{1} = \frac{E \{ {( s ( k ) + n ( k ) )}^{2} \}}{{\vert v - σ \vert}^{2} \cdot E \{ {n}^{2} ( k ) \}} = \frac{S + N}{{\vert v - σ \vert}^{2} \cdot N}$$

$$and$$

$${g}_{2} = \frac{{\vert v - σ \vert}^{2} \cdot E \{ {n}^{2} ( k ) \}}{E \{ {s}^{2} ( k ) \}} = {\vert v - σ \vert}^{2} \cdot \frac{N}{S} ,$$

where E{ . . . } is an expected value, S is a signal energy, and N is a noise energy. From the previous three equations, the following may be obtained:

SNR²+SNR<γ²|ν−σ|⁴,

where SNR=S/N. If the noise is in the same location as the target speech (i.e., σ=ν), this condition may not be met, so regardless of the SNR, adaptation may never happen. The further away from the target location the source is, the greater |ν−σ|⁴ and the larger the SNR is allowed to be while there is still adaptation attempting to cancel the noise.

In exemplary embodiments, adaptation may occur in frames where more signal is canceled in the second branch as opposed to the first branch. Thus, energies may be calculated after the first branch by the gain module 702 and g₁ determined. An energy calculation may also be performed in order to determine g₂ which may indicate if α is allowed to adapt. If γ²|ν−σ|⁴>SNR²+SNR⁴ is true, then adaptation of α may be performed. However, if this equation is not true, then α is not adapted.

The coefficient γ may be chosen to define a boundary between adaptation and non-adaptation of α. In an embodiment where a far-field source at 90 degree angle relative to a straight line between the microphones 106 and 108. In this embodiment, the signal may have equal power and zero phase shift between both microphones 106 and 108 (e.g., ν=1). If the SNR=1, then γ²|ν−σ|⁴=2, which is equivalent to γ=sqrt(2)/|1−σ|⁴.

Lowering γ relative to this value may improve protection of the near-end source from cancellation at the expense of increased noise leakage; raising γ has an opposite effect. It should be noted that in the microphones 106 and 108, ν=1 may not be a good enough approximation of the far-field/90 degrees situation and may have to substituted by a value obtained from calibration measurements.

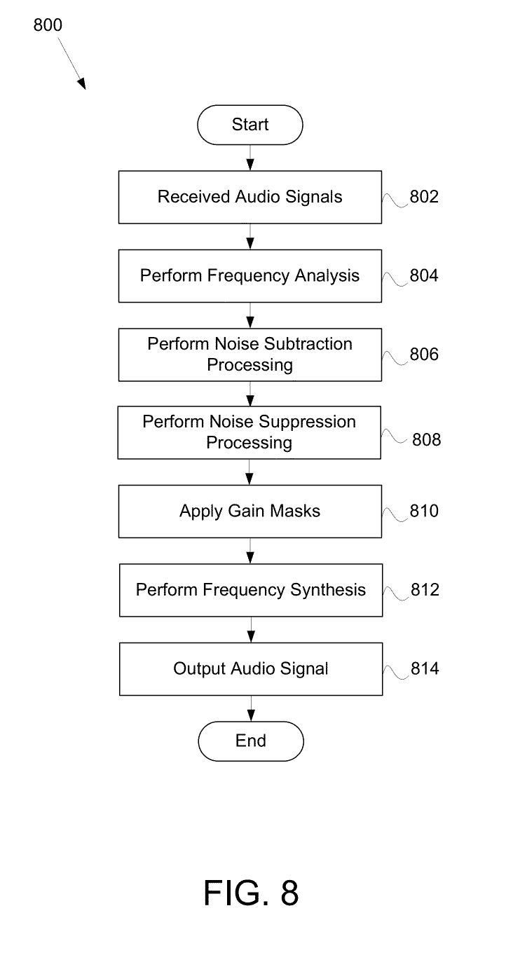

FIG. 8 is a flowchart 800 of an exemplary method for suppressing noise in an audio device. In step 802, audio signals are received by the audio device 102. In exemplary embodiments, a plurality of microphones (e.g., primary and secondary microphones 106 and 108) receive the audio signals. The plurality of microphones may comprise a close microphone array or a spread microphone array.

In step 804, the frequency analysis on the primary and secondary acoustic signals may be performed. In one embodiment, the frequency analysis module 302 utilizes a filter bank to determine frequency sub-bands for the primary and secondary acoustic signals.

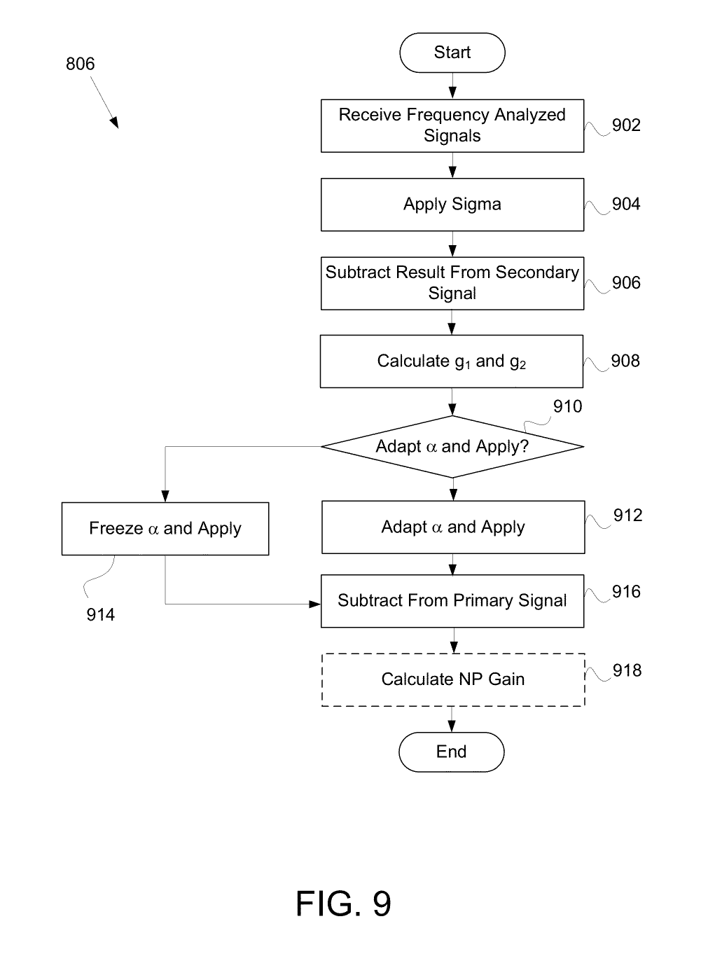

Noise subtraction processing is performed in step 806. Step 806 will be discussed in more detail in connection with FIG. 9 below.

Noise suppression processing may then be performed in step 808. In one embodiment, the noise suppression processing may first compute an energy spectrum for the primary or noise subtracted signal and the secondary signal. An energy difference between the two signals may then be determined. Subsequently, the speech and noise components may be adaptively classified according to one embodiment. A noise spectrum may then be determined. In one embodiment, the noise estimate may be based on the noise component. Based on the noise estimate, a gain mask may be adaptively determined.

The gain mask may then be applied in step 810. In one embodiment, the gain mask may be applied by the masking module 308 on a per sub-band signal basis. In some embodiments, the gain mask may be applied to the noise subtracted signal. The sub-bands signals may then be synthesized in step 812 to generate the output. In one embodiment, the sub-band signals may be converted back to the time domain from the frequency domain. Once converted, the audio signal may be output to the user in step 814. The output may be via a speaker, earpiece, or other similar devices.

Referring now to FIG. 9, a flowchart of an exemplary method for performing noise subtraction processing (step 806) is shown. In step 902, the frequency analyzed signals (e.g., frequency sub-band signals or primary signal) are received by the noise subtraction engine 304. The primary acoustic signal may be represented as c(k)=s(k)+n(k) where s(k) represents the desired signal (e.g., speech signal) and n(k) represents the noise signal. The secondary frequency analyzed signal (e.g., secondary signal) may be represented as f(k)=σs(k)+νn(k).

In step 904, σ may be applied to the primary signal by the analysis module 704. The result of the application of σ to the primary signal may then be subtracted from the secondary signal in step 906 by the summing module 708. The result comprises a noise component signal.

In step 908, the gains may be calculated by the gain module 702. These gains represent energy ratios of the various signals. In the first branch, a reference energy ratio (g₁) of how much of the desired component is removed from the primary signal may be determined. In the second branch, a prediction energy ratio (g₂) of how much the energy has been reduce at the output of the noise subtraction engine 304 from the result of the first branch may be determined.

In step 910, a determination is made as to whether α should be adapted. In accordance with one embodiment if SNR²+SNR<γ²|ν−σ|⁴ is true, then adaptation of α may be performed in step 912. However, if this equation is not true, then α is not adapted but frozen in step 914.

The noise component signal, whether adapted or not, is subtracted from the primary signal in step 916 by the summing module 708. The result is a noise subtracted signal. In some embodiments, the noise subtracted signal may be provided to the noise suppression engine 306 for further noise suppression processing via a multiplicative noise suppression process. In other embodiments, the noise subtracted signal may be output to the user without further noise suppression processing. It should be noted that more than one summing module 708 may be provided (e.g., one for each branch of the noise subtraction engine 304).

In step 918, the NP gain may be calculated. The NP gain comprises an energy ratio indicating how much of the primary signal has been cancelled out of the noise subtracted signal. It should be noted that step 918 may be optional (e.g., in close microphone systems).

The above-described modules may be comprised of instructions that are stored in storage media such as a machine readable medium (e.g., a computer readable medium). The instructions may be retrieved and executed by the processor 202. Some examples of instructions include software, program code, and firmware. Some examples of storage media comprise memory devices and integrated circuits. The instructions are operational when executed by the processor 202 to direct the processor 202 to operate in accordance with embodiments of the present technology. Those skilled in the art are familiar with instructions, processors, and storage media.

The present technology is described above with reference to exemplary embodiments. It will be apparent to those skilled in the art that various modifications may be made and other embodiments may be used without departing from the broader scope of the present technology. For example, the microphone array discussed herein comprises a primary and secondary microphone 106 and 108. However, alternative embodiments may contemplate utilizing more microphones in the microphone array. Therefore, there and other variations upon the exemplary embodiments are intended to be covered by the present technology.

What is claimed is:

1. A method for suppressing noise, comprising:
receiving at least a primary and a secondary acoustic signal;
subtracting a desired signal component from the secondary acoustic signal to obtain a noise component signal;
performing a first determination of at least one energy ratio related to the desired signal component and the noise component signal;
performing a second determination of whether to adjust the noise component signal based on the at least one energy ratio;
adjusting the noise component signal based on the second determination;
subtracting the noise component signal from the primary acoustic signal to generate a noise subtracted signal; and
outputting the noise subtracted signal.

2. The method of claim 1 wherein subtracting the desired signal component comprises applying a coefficient representing a source location to the primary acoustic signal to generate the desired signal component.

3. The method of claim 1 wherein the at least one energy ratio comprises a reference energy ratio and a prediction energy ratio.

4. The method of claim 3 further comprising adapting an adaptation coefficient applied to the noise component signal when the prediction energy ratio is greater than the reference energy ratio.

5. The method of claim 3 further comprising freezing an adaptation coefficient applied to the noise component signal when the prediction energy ratio is less than the reference energy ratio.

6. The method of claim 1 further comprising determining a NP gain based on the at least one energy ratio, the NP gain indicating how much of the primary acoustic signal has been cancelled out of the noise subtracted signal.

7. The method of claim 6 further comprising providing the NP gain to a multiplicative noise suppression system.

8. The method of claim 1 wherein the primary and secondary acoustic signals are separated into sub-band signals.

9. The method of claim 1 wherein outputting the noise subtracted signal comprises outputting the noise subtracted signal to a multiplicative noise suppression system.

10. The method of claim 9 wherein the multiplicative noise suppression system comprises generating a gain mask based at least on the noise subtracted signal.

11. The method of claim 10 further comprising applying the gain mask to the noise subtracted signal to generate an audio output signal.

12. A system for suppressing noise, comprising:
a microphone array configured to receive at least a primary and a secondary acoustic signal;
an analysis module configured to generate a desired signal component which may be subtracted from the secondary acoustic signal to obtain a noise component signal;
a gain module configured to perform a first determination of at least one energy ratio related to the desired signal component and the noise component signal;
an adaptation module configured to perform a second determination of whether to adjust the noise component signal based on the at least one energy ratio, the adaption module further configured to adjust the noise component signal based on the second determination; and
at least one summing module configured to subtract the desired signal component from the secondary acoustic signal and to subtract the noise component signal from the primary acoustic signal to generate a noise subtracted signal.

13. The system of claim 12 wherein the analysis module is configured to apply a coefficient representing a source location to the primary acoustic signal to generate the desired signal component.

14. The system of claim 12 wherein the at least one energy ratio comprises a reference energy ratio and a prediction energy ratio.

15. The system of claim 14 wherein the adaptation module is configured to adapt an adaptation coefficient applied to the noise component signal when the prediction energy ratio is greater than the reference energy ratio.

16. The system of claim 14 wherein the adaptation module is configured to freeze an adaptation coefficient applied to the noise component signal when the prediction energy ratio is less than the reference energy ratio.

17. The system of claim 12 wherein further comprising a gain module configured to determine a NP gain based on the at least one energy ratio, the NP gain indicating how much of the primary acoustic signal has been cancelled out of the noise subtracted signal.

18. A non-transitory machine readable storage medium having embodied thereon a program, the program providing instructions executable by a processor for suppressing noise using noise subtraction processing, the method comprising:
receiving at least a primary and a secondary acoustic signal;
subtracting a desired signal component from the secondary acoustic signal to obtain a noise component signal;
performing a first determination of at least one energy ratio related to the desired signal component and the noise component signal;
performing a second determination of whether to adjust the noise component signal based on the at least one energy ratio;
adjusting the noise component signal based on the second determination;
subtracting the noise component signal from the primary acoustic signal to generate a noise subtracted signal; and
outputting the noise subtracted signal.

19. The non-transitory machine readable storage medium of claim 18 wherein the at least one energy ratio comprises a reference energy ratio and a prediction energy ratio.

20. The non-transitory machine readable storage medium of claim 19 wherein the method further comprises adapting an adaptation coefficient applied to the noise component signal when the prediction energy ratio is greater than the reference energy ratio.
